(19) United States
(12) Patent Application Publication
(10) Pub. No.: US 2009/0322931 A1
(43) Pub. Date: Dec. 31, 2009

(54) DIGITAL CAMERA MODULE FOR PORTABLE ELECTRONIC DEVICE

(75) Inventor: YU-TSAN CHENG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: CHI MEI COMMUNICATION SYSTEMS, INC., Tu-Cheng City (TW)

(21) Appl. No.: 12/327,424

(22) Filed: Dec. 3, 2008

(30) Foreign Application Priority Data
Jun. 26, 2008 (CN) 200810302336.8

(51) Int. Cl. G03B 13/00

(52) U.S. Cl. 348/345; 348/E05.022

(57) ABSTRACT

A digital camera module (100) includes a housing (80), a lens module (10), an image sensing module (30) and a focusing module (40). The lens module is secured in the housing and exposes out of the housing to receive light reflected from an object. The image sensing module is mounted in the housing to receive the reflected light from the lens module and convert the light into a captured image, and includes a movable base and an image sensor installed in the base. The focusing mechanism is mounted in the housing for driving the base and the image sensor to gradually move relative to the lens module such that the digital camera module is steplessly focused.

### BACKGROUND

1. Field of the Invention

The present invention relates to digital camera modules for portable electronic devices, particularly to digital camera modules for portable electronic devices with stepless focusing mechanisms.

2. Description of Related Art

With the ongoing development of microcircuitry and multimedia technologies, digital cameras are now in widespread use. In addition, high-end portable electronic devices, such as mobile phones and personal digital assistants (PDAs), are increasingly multi-functional. Thus, many of these portable electronic devices are now equipped with digital camera modules. These electronic devices enable consumers to enjoy capturing digital pictures anytime and anywhere. Nevertheless, there is increasing consumer demand for high quality digital pictures.

When a digital camera module is used to capture pictures, it often needs to be focused to obtain an image having high quality. Generally, conventional digital camera modules can be classified into automatic focus digital camera modules and manual focus digital camera modules.

A typical automatic focus digital camera module usually includes a data processor and a gearing, wherein the gearing is connected to a lens of the digital camera module and controlled by the data processor. In use, a user inputs focusing instructions to the data processor, such as by pressing a button or turning a focusing ring. According to the focusing instructions, the data processor controls the gearing to move the lens to a predetermined position to focus the digital camera module. However, the data processor and the gearing increase costs, and the automatic focusing operation consumes much electric power.

A typical manual focus digital camera module allows the lens thereof to be manually moved, thereby adjusting the position of the lens to focus the digital camera module. However, many manual focus digital camera modules are focused in steps such that the lens module generally has only two or three focusing positions. Therefore, it is usually difficult to precisely move their lenses to appropriate focusing positions, and thus quality of the images captured by the digital camera module may be reduced.

Therefore, there is room for improvement within the art.

### BRIEF DESCRIPTION OF THE DRAWINGS

Many aspects of the present digital camera module can be better understood with reference to the following drawings. The components in the various drawings are not necessarily drawn to scale, the emphasis instead being placed upon clearly illustrating the principles of the present digital camera module. Moreover, in the drawings, like reference numerals designate corresponding parts throughout the diagrams.

FIG. 1 is a disassembled view of a digital camera module, according to an exemplary embodiment.

FIG. 2 is a schematic view of a first housing of the digital camera module shown in FIG. 1.

FIG. 3 is an assembled view of the digital camera module shown in FIG. 1.

### DETAILED DESCRIPTION OF THE EMBODIMENT

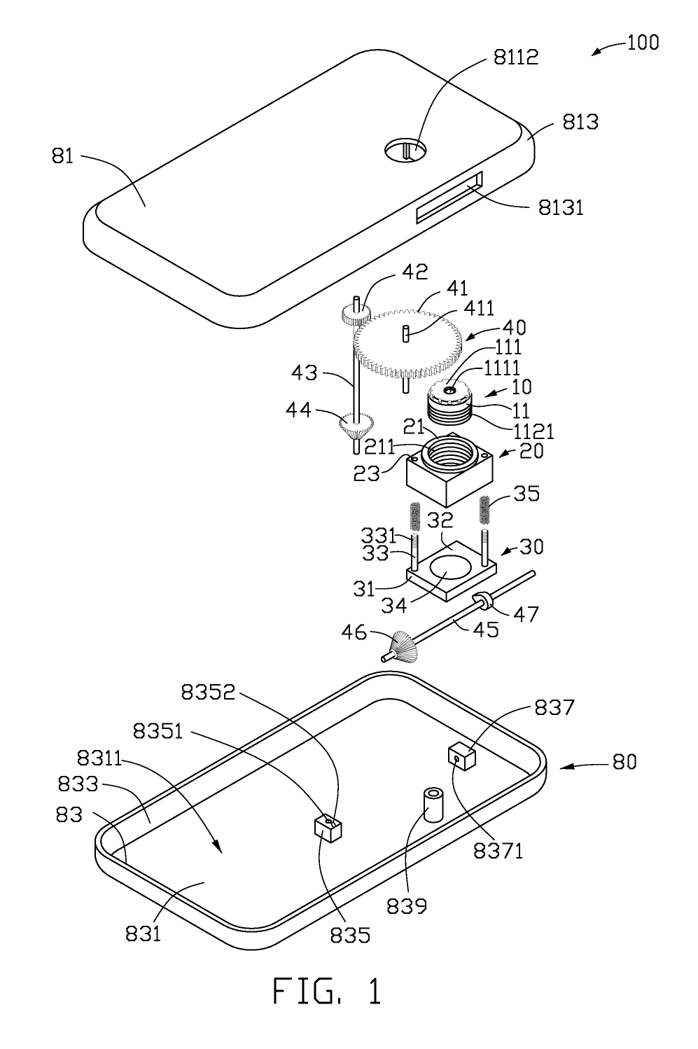

Referring to FIG. 1, a digital camera module 100 according to an exemplary embodiment is provided. The digital camera module 100 can be employed in a portable electronic device such as a mobile phone, a personal digital assistant (PDA), etc.

The digital camera module 100 includes a lens module 10, a lens pedestal 20, an image sensing module 30, a focusing mechanism 40 and a housing 80. The housing 80 can be a part of the housing of the portable electronic device. The lens pedestal 20 and the focusing mechanism 40 are mounted in the housing 80. The lens module 10 is secured to the lens pedestal 20 and exposed out of the housing 80. The image sensing module 30 is positioned on a light emitting path of the lens module 10 to receive the light reflected from the object being photographed and passing through the lens module 10. The focusing mechanism 40 adjusts the distance between the image sensing module 30 and the lens module 10 to focus the digital camera module 100.

The lens module 10 includes a hollow cylindrical lens barrel 11. At least one optical lens (not shown) can be securely mounted in the lens barrel 11 to receive the light reflected from the object. A top cover 111 is mounted on an end of the lens barrel 11 to partially close the end. The top cover 111 defines a focusing hole 1111, thereby allowing light coming from outside to pass through the lens barrel 11 and be received by the image sensing module 30 which converts the light into a captured image. Outer screw threads 1121 are formed on an outside surface of the lens barrel 11.

The lens pedestal 20 defines an assembling hole 21 therein. Inner screw threads 211 corresponding to the screw threads 1121 of the lens barrel 11 are formed on an inner surface of the lens pedestal 20. Thus, the lens barrel 11 can be screwed into the assembling hole 21 to assemble the lens module 10 to the lens pedestal 20. The lens pedestal 20 also defines leading holes 23, for example, in its two opposite corners. The leading holes 23 are positioned parallel to the axis of the assembling hole 21 and communicate with two opposite surfaces of the lens pedestal 20.

The image sensing module 30 includes a base 31 and an image sensor 34 integrated therewith. The base 31 includes a planar surface 32 and two leading poles 33 corresponding to the leading holes 23. The leading poles 33 perpendicularly protrude from two opposite corners of the planar surface 32. A length of each leading pole 33 is larger than the depth of each leading hole 23, and a diameter of each leading pole 33 is smaller than that of each leading hole 23. Screw threads 331 are formed on a distal end of each leading pole 33. The image sensing module 30 also includes a column spring 35 coiled over each leading pole 33. A diameter of each column springs 35 is larger than that of each leading pole 33 but smaller than that of each leading hole 23.

The focusing mechanism 40 includes an adjusting wheel 41, a first gear 42, a first driving axle 43, a second gear 44, a second driving axle 45, a third gear 46 and a focusing cam 47. The adjusting wheel 41 is a gear including a supporting axle 411 formed on a central portion thereof and positioned coaxial to the adjusting wheel 41. One end of the supporting axle 411 is rotatably mounted on the housing 80. A part of the adjusting wheel 41 exposes out of the housing 80, thus the adjusting wheel 41 can be manually rotated. The first gear 42 and the second gear 44 are respectively coaxially secured on two ends of the first driving axle 43. The third gear 46 is coaxially secured on an end of the second driving axle 45. The first gear 42 meshes with the adjusting wheel 41. The second gear 44 and the third gear 46 may be conical gears and mesh with each other, with the axes thereof being positioned perpendicular to each other. The focusing cam 47 is secured on a middle portion of the second driving axle 45.

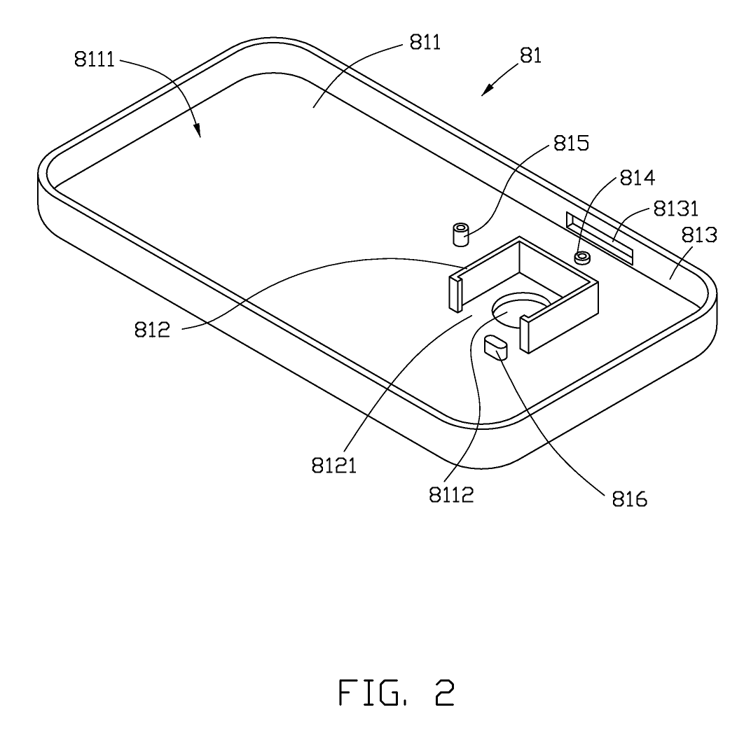

Also referring to FIG. 2, the housing 80 includes a first shell 81 and a second shell 83. The first shell 81 includes a first panel 811, a receiving frame 812, a first assembling frame 813, a first bushing member 814, a second bushing member 815 and a limiting member 816.

The first panel 811 includes a planar first assembling surface 8111 and a lens hole 8112 defined therein to receive the lens module 10. The receiving frame 812 defines a gap 8121 in one sidewall thereof. The receiving frame 812 is secured on the first assembling surface 8111 and partially surrounds the lens hole 8112. The shape of the first assembling frame 813 corresponds to a shape of the first panel 811. The first assembling frame 813 surrounds the first panel 811 and is perpendicularly connected to the edge of the first assembling surface 8111. An adjusting aperture 8131 is defined in a sidewall of the first assembling frame 813 adjacent to the receiving frame 812 to expose a part of the adjusting wheel 41 out of the housing 80.

The first bushing member 814 and the second bushing member 815 are hollow cylinders formed on the first assembling surface 8111 and perpendicularly protruding therefrom. The first bushing member 814 is positioned adjacent to the adjusting aperture 8131, and an inner diameter of the first bushing member 814 is equal to a diameter of the supporting axle 411 for rotatably receiving an end the supporting axle 411 therein. The second bushing member 815 is positioned adjacent to the receiving frame 812, and an inner diameter of the second bushing member 815 is equal to a diameter of the first driving axle 43 for rotatably receiving an end the first driving axle 43 therein. The limiting member 816 is a protrusion formed on the first assembling surface 8111 and positioned adjacent to the gap 8121 to limit movement of the lens module 10.

The second shell 83 includes a second panel 831 corresponding to the first panel 811, a second assembling frame 833 corresponding to the first assembling frame 813, a first assembling block 835, a second assembling block 837 and a third bushing member 839. The second panel 831 includes a planar second assembling surface 8311. The shape of the second assembling frame 833 corresponds to a shape of second panel 831. The second assembling frame 833 surrounds the second panel 831 and is perpendicularly connected to the edge of the second assembling surface 8311.

The first assembling block 835 and the second assembling block 837 are protrusions formed on the second assembling surface 8311. The first assembling block 835 defines a first axle hole 8351 and a second axle hole 8352 therein, with the axes thereof being positioned perpendicular to each other. The first axle hole 8351 corresponds to the first driving axle 43 and the second bushing member 815 for rotatably receiving another end of the first driving axle 43 therein. The second axle hole 8352 corresponds to the second driving axle 45 for rotatably receiving an end of the second driving axle 45 therein. The second assembling block 837 defines a third axle hole 8371 corresponding to the second driving axle 45 and the second axle hole 8352 for rotatably receiving another end of the second driving axle 45 therein. The third bushing member 839 is a hollow cylinder formed on the second assembling surface 8311 and perpendicularly protruding therefrom. The third bushing member 839 is positioned corresponding to the supporting axle 411, and an inner diameter of the third bushing member 839 is equal to a diameter of the supporting axle 411 for rotatably receiving another end of the supporting axle 411 therein.

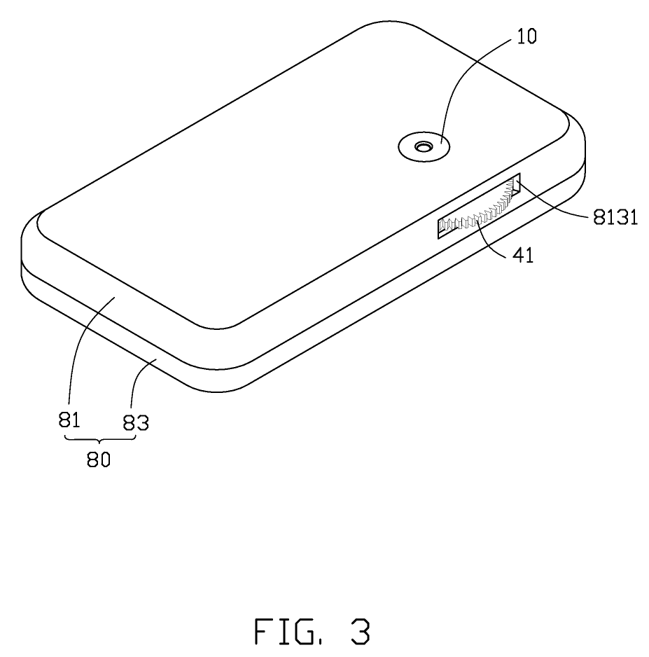

Referring to FIGS. 1 and 3, in assembly, the two column springs 35 are respectively coiled on the two leading poles 33. The two leading poles 33 are respectively inserted into the two leading holes 33 until the ends thereof protrude out of the leading holes 23. Nuts (not shown) are screwed onto the screw threads 331 such that the image sensing module 30 is movably mounted to the lens pedestal 20. Thus, the image sensing module 30 is aligned with the assembling hole 21, and the column springs 35 are limited and compressed between the lens pedestal 20 and the base 31.

The lens module 10 is screwed in the assembling hole 21 and secured on the pedestal 20 using the outer screw threads 1121 and the inner screw threads 211. Thus, the lens module 10 is secured and is aligned with the image sensor 34 to direct light thereto. The lens pedestal 20 is then secured in the receiving frame 812, and the limiting member 816 can be used to retain the lens pedestal 20. The lens module 10 is exposed out of the housing 80 from the lens hole 8112 to receive light reflected from the object.

The focusing mechanism 40 is mounted in the housing 80. Two ends of the supporting axle 411 are respectively rotatably received in the first bushing member 814 and the third bushing member 839, and the adjusting wheel 41 is partially exposed out of the adjusting aperture 8131. Two ends of the first driving axle 43 are respectively rotatably received in the second bushing member 815 and the first axle hole 8351. Two ends of the second driving axle 45 are respectively rotatably received in the second axle hole 8352 and the third axle hole 8371. The focusing cam 47 is positioned to be in contact with a surface of the base 31 which is opposite to the planar surface 32, such that rotation of the focusing cam 47 can push the base 31 to move towards the lens module 10. Finally, the first assembling frame 813 and the second assembling frame 833 are connected to each other, thus the first shell 81 and the second shell 83 are combined together to form the housing 80 enveloping the lens module 10, the lens pedestal 20, the image sending module 30 and the focusing mechanism 40 therein.

In use, the exposed adjusting wheel 41 is manually rotated, and then drives the first gear 42, the first driving axle 43, the second gear 44, the third gear 46, the second axle 45 and the focusing cam 47 to rotate. Thus, the base 31 with the image sensor 34 mounted adjacent to the lens module 10 is correspondingly moved, and the distance between the base 31 with the image sensor 34 installed therein and the lens module 10 is adjusted to focus the digital camera module 100.

Particularly, in rotation of the focusing cam 47, when a part of the focusing cam 47 having a relative large radius is rotated towards the base 31, a distance between the base 31 and the axis of the second driving axle 45 (i.e., a radius of the focusing cam 47) is increased, and the base 31 is pushed towards the lens module 10. A distance between the base 31 and the lens module 10 is decreased, and the column springs 35 are further compressed. When a part of the focusing cam 47 having a relative small radius is rotated towards the base 31, a distance between the base 31 and the axis of the second driving axle 45 (i.e., a radius of the focusing cam 47) is decreased. The base 31 is pushed towards the focusing cam 47 by the column springs 35 until being in tight contact with the focusing cam 47, and then distance between the base 31 and the lens module 10 is increased. In this way, the digital camera module 100 can be focused through changing distance between the base 31 with the image sensor 34 installed therein and the lens module 10.

In the digital camera module 100, focusing position thereof is manually adjusted through the rotation of the focusing cam 47. When the focusing cam 47 is rotated, the distance between the image sensor 34 and the lens module 10 changes gradually. Thus, the digital camera module 100 can be focused steplessly. Compared with conventional digital camera modules focused in steps, the digital camera module 100 can be focused much more precisely.

Understandably, the adjusting aperture 8131 can also be defined in other positions of the housing 80. The adjusting wheel 41 can also be driven by electrical power, for example, a electromotor can be employed in the digital camera module 100 to drive the adjusting wheel 41. Further, besides gears and straight axles, the adjusting wheel 41 can drive the focusing cam 47 to rotate through other gearings, such as driving tapes, stepped axles, etc., and can also directly mesh with the third gear 46 to drive the focusing cam 47. The number of the leading holes 23 and the leading poles 33 can be more than two.

It is to be further understood that even though numerous characteristics and advantages of the present embodiments have been set forth in the foregoing description, together with details of structures and functions of various embodiments, the disclosure is illustrative only, and changes may be made in detail, especially in matters of shape, size, and arrangement of parts within the principles of the present invention to the full extent indicated by the broad general meaning of the terms in which the appended claims are expressed.

What is claimed is:

1. A digital camera module, comprising:
a housing;
a lens module secured in the housing and exposed out of the housing to receive light reflected from an object;
an image sensing module mounted in the housing to receive the reflected light from the lens module and convert the light into a captured image, the image sensing module including a movable base and an image sensor integrated with the base; and
a focusing mechanism mounted in the housing for driving the base and the image sensor to gradually move relative to the lens module such that the digital camera module is steplessly focused.

2. The digital camera module as claimed in claim 1, further comprising a lens pedestal secured in the housing, and the lens module is secured to the lens pedestal.

3. The digital camera module as claimed in claim 2, wherein the pedestal defines a plurality of leading holes therein and the image sensing module includes a plurality of leading poles corresponding to the leading holes, each leading pole being inserted into a corresponding leading hole to movably mount the image sensing module to the lens pedestal.

4. The digital camera module as claimed in claim 3, wherein the image sensing module includes a plurality of springs corresponding to the leading poles, and each spring is coiled on its corresponding leading pole and compressed between the lens pedestal and the base.

5. The digital camera module as claimed in claim 1, wherein the focusing mechanism includes a focusing cam rotatably mounted in the housing and being in contact with the base, and rotation of the focusing cam gradually pushes the base towards the lens module.

6. The digital camera module as claimed in claim 5, wherein the focusing mechanism includes an adjusting wheel driving the focusing cam to rotate.

7. The digital camera module as claimed in claim 6, wherein the housing defines an adjusting aperture therein, the adjusting wheel exposes out of the housing from the adjusting aperture for being manually rotated to drive the focusing cam to rotate.

8. The digital camera module as claimed in claim 6, wherein the focusing mechanism includes a plurality of gears and driving axles mounted in the housing and configured for transferring rotation of the adjusting wheel to the focusing cam.

9. A digital camera module, comprising:
a lens module configured to receive light reflected from an object;
an image sensing module configured to receive the reflected light from the lens module and convert the light into a captured image, the image sensing module including a movable base and an image sensor installed in the base; and
a focusing mechanism configured for focusing the digital camera module and including a focusing cam being in contact with the base, wherein rotation of the focusing cam drives the base and the image sensor to gradually move relative to the lens module such that the digital camera module is steplessly focused.

10. The digital camera module as claimed in claim 9, further comprising a housing for receive the lens module, the image sensing module and the focusing mechanism therein.

11. The digital camera module as claimed in claim 10, further comprising a lens pedestal secured in the housing, and the lens module is secured to the lens pedestal.

12. The digital camera module as claimed in claim 11, wherein the pedestal defines a plurality of leading holes therein and the image sensing module includes a plurality of leading poles corresponding to the leading holes, each leading pole being inserted into a corresponding leading hole to movably mount the image sensing module to the lens pedestal.

13. The digital camera module as claimed in claim 12, wherein the image sensing module includes a plurality of springs corresponding to the leading poles, and each spring is coiled on its corresponding leading pole and compressed between the lens pedestal and the base.

14. The digital camera module as claimed in claim 9, wherein the focusing mechanism includes an adjusting wheel driving the focusing cam to rotate.

15. The digital camera module as claimed in claim 14, wherein the adjusting wheel exposes out of the digital camera module for being manually rotated to drive the focusing cam to rotate.

16. The digital camera module as claimed in claim 15, wherein the focusing mechanism includes a plurality of gears and driving axles mounted in the housing and configured for transferring rotation of the adjusting wheel to the focusing cam.
